(19) United States
(12) Patent Application Publication
(10) Pub. No.: US 2024/0266981 A1
(43) Pub. Date: Aug. 8, 2024

(54) METHOD OF OPERATING AN INVERTER, INVERTER AND MOTOR VEHICLE

(71) Applicant: AUDI AG, Ingolstadt (DE)

(72) Inventors: Cornelius RETTNER, Lauf an der Pegnitz (DE); Daniel RUPPERT, Lenting (DE); Adrian AMLER, Nürnberg (DE)

(21) Appl. No.: 18/430,403

(22) Filed: Feb. 1, 2024

(30) Foreign Application Priority Data
Feb. 2, 2023 (DE) 102023102550.3

(51) Int. Cl. H02P 27/06; B60L 15/00

(52) U.S. Cl. CPC H02P 27/06; B60L 15/007

(57) ABSTRACT

A method for operating an inverter with a plurality of half bridges, each including two switching devices that connect respective bridge center points of the half bridges to DC voltage potentials, wherein switching takes place between different inverter states, wherein at least one of the switching devices has variable switching behavior and includes a parallel connection of two semiconductor switches that are configured differently from one another, wherein, for at least two temporally successive switching operations of the at least one of the switching devices from a conducting switching state to a blocking switching state, activating the semiconductor switches using first activation patterns, and/or, for at least two temporally successive switching operations of the at least one of the switching devices from the blocking switching state to the conducting switching state, activating the semiconductor switches using second activation patterns.

### BACKGROUND

### Technical Field

The disclosure relates to a method for operating an inverter with a plurality of half bridges, each of which comprises two switching devices that connect a bridge center point of the respective half bridge to a respective DC voltage potential, wherein the switching devices can each be switched between a conducting and a blocking switching state, wherein switching takes place between different inverter states, each of which differs from one another with respect to the switching state of both switching devices of at least one of the half bridges. The disclosure also relates to an inverter and a motor vehicle.

### Description of the Related Art

Inverters are used, among other things, for supplying current to alternating current consumers from direct voltage networks. By way of example, drive inverters are used in electric motor vehicles to provide alternating currents, in particular a three-phase current, for the drive motor. Semiconductor switches are generally used as the switching devices or alternatively as the active part of the switching devices. Currently, silicon IGBTs (“insulated-gate bipolar transistors” or alternatively bipolar transistors with an insulated gate electrode) are predominantly used.

In the case of a blocking switching state, as a rule, only the current flow in a so-called forward direction is usually blocked or alternatively a very high resistance results in this forward direction. A current flow in the reverse direction, opposite to the forward direction, is typically possible independently of the switching state, in particular via a diode connected in parallel to the semiconductor switch or alternatively an intrinsic diode of the switching devices. In the conductive switching state, a current flow in the forward direction is then also possible or alternatively the resistance of the switching devices in the forward direction is significantly reduced or alternatively reduced by several orders of magnitude compared to the blocking switching state.

To achieve higher efficiencies, it can be advantageous to use faster switching semiconductor switches, in particular silicon carbide MOSFETs (metal oxide semiconductor field effect transistors). The higher switching speeds can, however, lead to a greater load on the components involved, for example, the insulation of the drive machine, as well as to an increased emitted interference. This may require the use of relatively complex filters to improve electromagnetic compatibility both on the DC voltage side and on the AC voltage side of the inverter. Alternatively or supplementally, the switching speed of silicon carbide MOSFETs can also be artificially slowed down in order to avoid or alternatively minimize the aforementioned problems, which can, for example, be useful or even necessary in order to use silicon carbide MOSFETs in the usual way in drive inverters of motor vehicles.

In principle, it is also known to use different types of semiconductor switches within an inverter in order to optimize the properties of the inverter for specific applications. By way of example, US 2009/0316457 A1 proposes connecting the bridge center point of the respective half bridge to the positive DC voltage potential on the one hand and to the negative DC voltage potential on the other, via different types of semiconductor switches.

### BRIEF SUMMARY

The disclosure is based on the task of reconciling an increase in efficiency of rectifiers by way of short switching times of the switching devices used in the half bridges on the one hand and, on the other hand, to further improve a lowest possible emitted interference or alternatively a best possible electromagnetic compatibility.

Embodiments of the disclosure provide a method of the type mentioned at the beginning, wherein at least one of the switching devices, in particular each of the switching devices, is a switching devices which is variable with respect to its switching behavior and which comprises a parallel connection of two semiconductor switches which are configured differently from one another, wherein, for at least two temporally successive switching operations of the respective variable switching devices from the conducting switching state to the blocking switching state, different activation patterns are used to activate the semiconductor switch, and/or wherein, for at least two temporally successive switching operations of the respective variable switching devices from the blocking switching state to the conducting switching state, a plurality of different activation patterns is used to activate the semiconductor switch.

It was recognized that during a conventional operation of inverters, for example, when using space vector modulation to power a three-phase motor, different changes in the inverter states result in different levels of emitted interference into the DC or alternatively AC voltage network or alternatively into at least one AC voltage-side component connected to the inverter, for example, the three-phase motor. In particular, changes in the inverter state, in which the switching state of a plurality of half bridges changes, typically lead to a considerably higher emitted interference than changes in the semiconductor state, in which, for example, only the switching state of a single half bridge changes. When using space vector modulation, for example, the change to or alternatively from the so-called null vector, which is to say, from or alternatively to states in which all bridge center points are connected to the same DC voltage potential, is highly relevant for the emitted interference, inasmuch as switching state changes can occur for two or even three half bridges.

By a suitable selection of an activation pattern for the semiconductor switch of the respective switching devices, in particular by selection of the sequence or alternatively the temporal interval between the activation of the two semiconductor switches, it is possible to specify whether the switching speed, which is to say, the rapidity of the change of the resistance of the switching devices, is determined or at least dominated by the properties of the first or the second switching devices.

When the switching devices are switched to a conductive state, the switching speed is dominated by the semiconductor switch that switches first or alternatively, in the case of essentially simultaneous activation, by the semiconductor switch that switches faster. If the faster switching semiconductor switch is thus activated at the same time as the slower switching semiconductor switch or before it, the resistance of the entire switching device is very quickly reduced, which can be advantageous on the grounds of efficiency. If, on the other hand, the slower switching semiconductor switch is switched noticeably before the faster switching semiconductor switch, this results in a slower drop in resistance and therefore, indeed, typically a slightly lower efficiency, but at the same time a lower emitted interference.

When the respective switching device is switched to a blocking state, the resistance of the switching device increases very quickly in the reverse direction, which is to say, opposite to the forward direction of a typically used, parallel-connected, or alternatively intrinsic diode, if the faster switching semiconductor switch is activated after the slower switching semiconductor switch, whereby a high degree of efficiency is achieved. If, on the other hand, the slower switching semiconductor switch is activated at the same time or after the faster switching semiconductor switch, a somewhat slower change in resistance occurs, resulting in somewhat higher switching losses on the one hand, but on the other, a reduction in emitted interference.

By using different activation patterns to activate the semiconductor switch depending on the operating situation of the inverter, slower switching and thus better electromagnetic compatibility can be achieved in cases or alternatively in switching processes that are critical with regard to electromagnetic compatibility, which is to say, in particular when a plurality or all half bridges is to be switched, whereas in all other cases a faster switching and thus efficiency optimization can occur.

In particular, precisely two or at least two activation patterns can be used for switching from the conducting to the blocking switching state and/or precisely two or at least two activation patterns can be used for switching from the blocking to the conducting switching state, from which a selection can be made as required in order to balance out between fast switching and thus high efficiency and a reduction in interference radiation for the respective switching operation.

The first and second semiconductor switches can be semiconductor switches with different semiconductor technology, for example a MOSFET and an IGBT, it is, however, also possible that the same semiconductor technology is used for both semiconductor switches and that the semiconductor switches differ, for example, in terms of their gate capacitance or gate resistance, whereby different switching speeds or alternatively switching times or the like also result.

During operation of the inverter, a cyclical change of inverter states can, in particular, take place. In this, at least some of the inverter states can, in particular, be used several times within a cycle. By way of example, in the case of space vector modulation, each inverter state can correspond to one of the space vectors and neighboring space vectors or alternatively inverter states can be used alternately over a certain period of time with different scanning intervals in order to output intermediate angles of the space vector and/or null vectors can be used intermittently in order to set the amplitude of a provided AC voltage.

The activation pattern, which is used to activate the variable switching devices or at least one of the variable switching devices when the inverter state changes in order to change its switching state, can depend on a phase of an AC voltage provided or present at at least one of the bridge center points, and/or on the phase of an AC current provided or supplied at at least one of the bridge center points, and/or on the number of half bridges whose switching devices are switched when the inverter state changes.

The phase of the AC voltage or alternatively alternating current correlates with a specific point in the sequence of inverter states or alternatively space vectors in the case of space vector modulation or alternatively generally in the case of cyclical changes of inverter states and therefore, for example, for sections of the switching cycle for which a particularly high emitted interference would result if the activation pattern were always the same, a activation pattern can be selected that leads to a lower emitted interference, in particular due to slower switching operations, as elucidated above.

As also already elucidated above, it can generally be assumed that the strength of the emitted interference correlates with the number of simultaneously switched half bridges when changing the inverter state, so that by taking this number into account, the emitted interference can be reduced in a particular robust and simple manner, wherein a negative influence on the efficiency of the inverter state can simultaneously be kept within limits By way of example, the activation pattern, which leads to a slower switching process, can then always be used if two or more half bridges are to be switched essentially simultaneously in an inverter with three half bridges, for example, an inverter for three-phase current.

A first of the semiconductor switches can have a shorter switching time for a change from a blocking to a conducting semiconductor switching state and/or from the conducting to the blocking semiconductor switching state than a second of the semiconductor switches. In particular, the time from the specification of a suitable gate voltage, for example a digital signal, until the maximum or alternatively minimum resistance of the semiconductor switch is reached, can be regarded as the switching time. As already elucidated above, different switching times can, in particular, result from the use of different semiconductor technologies for the semiconductor switch, however also from different gate resistances, gate capacitances or other design differences.

A MOSFET, in particular a silicon carbide MOSFET, can be used as the first semiconductor switch. Supplementally or alternatively, an IGBT, in particular a silicon IGBT, can be used as the second semiconductor switch. As already elucidated, particularly short switching times and therefore particularly high inverter efficiencies can be achieved through the use of silicon carbide MOSFETs. Silicon IGBTs have noticeably longer switching times and are therefore particularly suitable for reducing emitted interferences through slower switching. By connecting the different types of semiconductor switches mentioned in parallel, it is moreover potentially possible to improve the current carrying capacity or alternatively thermal management in the inverter.

To activate the semiconductor switch for the switching of the variable switching devices or at least one of the variable switching devices from the conducting switching state to the blocking switching state, a first activation pattern can be used if a triggering condition is not fulfilled, the fulfillment of which triggering condition indicates in particular the presence of a switching of the inverter state that is critical for electromagnetic compatibility, and a second activation pattern can be used if the triggering condition is fulfilled, wherein in the second activation pattern the second semiconductor switch, starting from the point in time of activation of the first semiconductor switch, is activated later than in the first activation pattern.

A switching that is critical for the electromagnetic compatibility exists, in particular, if the change of inverter state to be performed would result in above-average emitted interference when using the first activation pattern, and/or if a plurality of half bridges is switched simultaneously. The fulfillment of the triggering condition can therefore, as elucidated above, depend in particular on the phase of the AC voltage provided or present at at least one of the bridge center points or alternatively on the AC current there or alternatively on the number of switched half bridges. Supplementally or alternatively, the fulfillment of the triggering condition can, however, also depend on an emitted interference for the switching that is estimated using a model or an algorithm that evaluates the triggering condition that can be trained, for example, using a machine learning method.

As elucidated above, the switching speed is dominated by the semiconductor switch that switches later when the switching device is switched to the blocking switching, whereby, through the delaying of the switching of the slower switching semiconductor switch, the emitted interference can be reduced.

In order to achieve the shortest possible switching times for uncritical switching operations, it can be advantageous if the faster switching semiconductor switch is activated after the slower switching semiconductor switch in the first activation pattern. In the second activation pattern, simultaneous activation or reversal of the activation sequence can then take place or at least the interval between the activation points in time can be reduced. In principle, it would also be possible for the first and second semiconductor switches to be activated simultaneously in the first activation pattern or alternatively for the second semiconductor switch to be activated after the first semiconductor switch. In this case, in the second activation pattern, it is possible that the second semiconductor switch is only activated after the first semiconductor switch has been activated or alternatively the time interval between the activations can be increased.

To activate the semiconductor switch for the switching of the variable switching devices or at least one of the variable switching devices from the blocking to the conducting switching state, a third activation pattern can be used if the triggering condition or a triggering condition is not fulfilled, the fulfillment of which indicates, in particular, the presence of a switching of the inverter state which is critical for electromagnetic compatibility and, in the case of fulfillment of the triggering condition, a fourth activation pattern is used, whereby, starting from the point in time of the triggering of the first semiconductor switch, wherein in the fourth activation pattern either the second semiconductor switch is activated earlier than in the third activation pattern, or only the second semiconductor switch is activated. The designation of the activation pattern as third and fourth activation pattern serves exclusively to unequivocally identify the activation pattern and does not necessarily require the presence or alternatively use of the first and/or second activation pattern elucidated above.

As already discussed above, the switching speed of the entire switching device is dominated by the semiconductor switch that switches first when the respective switching devices switches a conductive state, whereby in order to reduce emitted interferences, the switching of the slower semiconductor switch can be advantageous compared to the switching of the faster semiconductor switch, which corresponds to a delay in the switching of the faster switching semiconductor switch.

If very short switching phases are used, for example in the case of a short intermittent use of null vectors in a space vector modulation, such a delay in the switching of the first semiconductor switch would potentially result in it only remaining switched on for a very short time or alternatively a switching on of this semiconductor switch would only first occur if a switching off of the switching devices would have been desired. It is therefore also possible that an activation pattern is used as the fourth activation pattern in which only the second semiconductor switch is activated.

It is also possible, depending on an expected holding time of the inverter state to be set, to select whether a fourth activation pattern is used, in which, starting from the point in time of the activation of the first semiconductor switch, the second semiconductor switch is activated earlier than in the third activation pattern, or a fourth activation pattern is used, in which only the second semiconductor switch is activated.

The fulfilment of the triggering condition may depend on whether, when the inverter state changes from a previous inverter state to a new inverter state, the previous and/or the new inverter state is an inverter state in which the bridge center points of all half bridges are connected to the same DC voltage potential. This is the case, for example, with the null vectors in a space vector modulation. Corresponding inverter states are particularly relevant for electromagnetic compatibility, inasmuch as a plurality of the half bridges is often switched when changing to or alternatively from such an inverter state, whereas in the case of space vector modulation, for example, only one semiconductor bridge usually switches when changing between neighboring space vectors.

In addition to the method according to the disclosure, the disclosure relates to an inverter having a plurality of half bridges, each of which comprises two switching devices for connecting a bridge center point of the respective half bridge to a respective DC voltage potential, and a control device for controlling the switching devices, wherein at least one of the switching devices, in particular each of the switching devices, is a switching devices which is variable with respect to its switching behavior and comprises a parallel connection of two semiconductor switches which are designed differently from one another, wherein the control device is set up for controlling the switching devices in accordance with the method according to the disclosure.

The inverter according to the disclosure is, in particular, configured to carry out the method according to the disclosure or alternatively the method according to the disclosure can be implemented by using an inverter according to the disclosure. Irrespective of this, the features and advantages of the method according to the disclosure can be transferred to the inverter according to the disclosure and vice versa.

The disclosure also relates to a motor vehicle comprising an inverter according to the disclosure. The inverter may, in particular, be used to supply current to a drive motor of the motor vehicle. Use of the inverter in motor vehicles, in particular for supplying current to a drive motor, is particularly advantageous, inasmuch as relatively strong currents are inverted there, wherein potentially high emitted interferences can occur, wherein at the same time there are high requirements for electromagnetic compatibility.

### BRIEF DESCRIPTION OF THE SEVERAL VIEWS OF THE DRAWINGS

Further advantages and details of the disclosure are shown in the following embodiments and the associated drawings, wherein:

FIG. 1 shows a schematic representation of an embodiment example of a motor vehicle according to the disclosure, comprising an embodiment example of an inverter according to the disclosure,

FIG. 2 shows a detailed schematic representation of the embodiment of one of the switching devices in FIG. 1,

FIG. 3 shows a schematic representation of a flow chart of an embodiment of the method according to the disclosure, and

FIG. 4 to FIG. 8 show a schematic representation of various activation patterns that can be used in the inverter shown in FIG. 1 or alternatively the method shown in FIG. 3.

### DETAILED DESCRIPTION

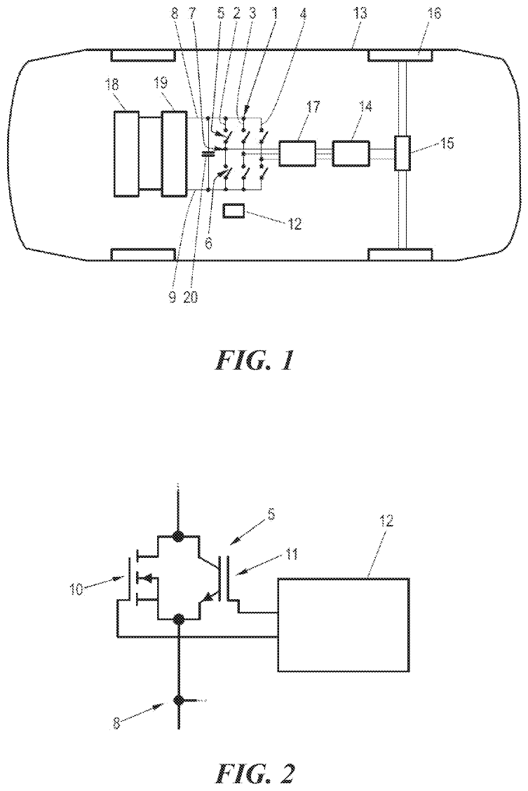

FIG. 1 shows a motor vehicle 13 the drive motor 14 of which, in the example, drives the wheels 16 via a differential 15 and is powered from a DC network 18 by an inverter 1. The inverter 1 comprises a plurality of half bridges 2, 3, 4, each comprising two switching devices 5, 6 for connecting a respective bridge center point 7 to a respective DC voltage potential 8, 9 of the DC voltage network 18.

In order to achieve a high degree of efficiency of the inverter 1, it is advantageous to use switching devices 5, 6 that have or alternatively can implement relatively short switching times. As already discussed in the general section, the use of switching devices 5, 6 with very short, fixed switching times does however lead to a high level of emitted interference, in particular, if the switching state of a plurality of the half bridges 2-4 changes simultaneously.

In principle, it would indeed be possible to largely suppress the coupling of interference in the DC electrical system 18, which system can, in particular, be a high-voltage system, by selecting a suitable DC link capacitor 20 and a suitable interference suppression filter 19, however, this would require a relatively complex interference suppression filter 19. Similarly, the coupling of interference in the AC voltage network or alternatively the drive motor 14 can also be largely suppressed by a suitable interference suppression filter 17, wherein, however, this would also require a relatively high level of technical effort.

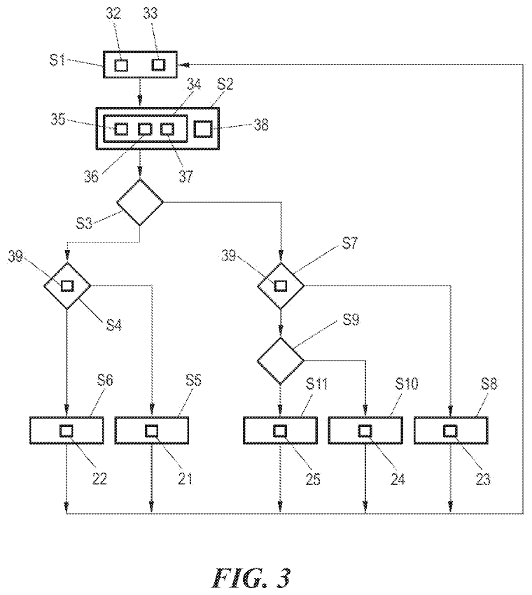

In the motor vehicle 13, or alternatively the inverter 1, variable switching devices 5, 6 are therefore used as switching devices 5, 6, which, as shown in FIG. 2 in a detailed view of the switching devices 5, each comprise two semiconductor switches 10, 11 that are connected in parallel to each other. In the example, the semiconductor switches 10, 11 differ in terms of their switching times, which is to say, the time that elapses after a control signal has been output to the gate of the respective semiconductor switch 10, 11 by the control device 12 until, in the case of a conductive switching, the minimum resistance is reached or alternatively, in the case of a blocking switching, the maximum resistance is reached in the blocking direction of the respective semiconductor switch 10, 11.

In the example, this results from the fact that a silicon carbide MOSFET is used as the first semiconductor switch 10, wherein this type of semiconductor generally has significantly shorter switching times than the silicon IGBT used in the example as the second semiconductor switch 11.

By selecting a suitable activation pattern, which is to say, in particular a chronological sequence of the signal output to the semiconductor switches 10, 11, it can thus be achieved, as already elucidated in detail in the general section, that the switching duration of the entire switching device is either dominated by the switching behavior of the fast-switching first semiconductor switch 10 or by the switching behavior of the noticeably slower-switching second semiconductor switch 11. In this way, by selecting a suitable activation pattern, it is possible to choose between fast and slow switching of the entire variable switching devices 5, 6.

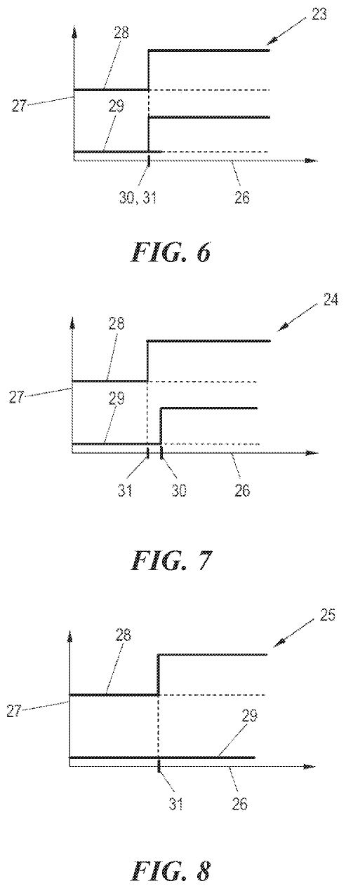

A slow switching of the entire switching devices 5, 6 can be selected, for example, if a plurality of the semiconductor bridges is to be switched in an essentially simultaneous manner in order to mitigate the high emitted interferences that potentially occur with fast switching. In the case of inverter state changes, which generally occur considerably more frequently and only require changes to the switching state of one of the semiconductor bridges 2-4, an activation pattern can be used for fast switching of the entire switching devices 5, 6 in order to minimize switching losses and thus optimize the efficiency of the inverter 1. Suitable activation patterns for the various switching processes will be elucidated in more detail later with reference to FIGS. 4-8.

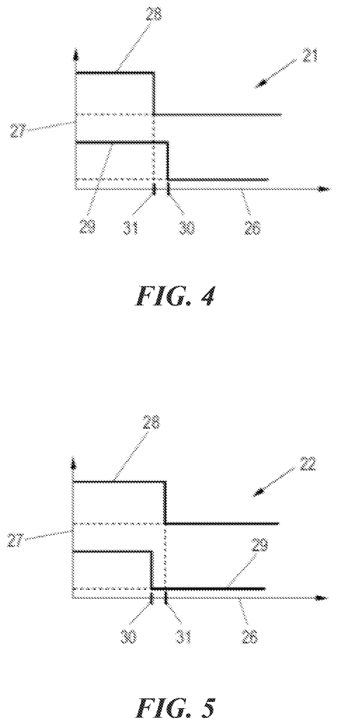

A flow chart for an exemplary method for operating the inverter 1 is elucidated below with additional reference to FIG. 3. In this flow chart, it is assumed here that the activation of the inverter 1 and therefore, in particular, the selection of the inverter state 34 to respectively be used next, takes place in accordance with a space vector modulation and thus as a function of a phase 32 and an amplitude 33 of the alternating current to be provided. These variables are specified in step S1 either by a phase counter of the control device 12 itself or via an external device not shown.

In step S2, based on the phase 32 and the amplitude 33, an inverter state 34 to be adopted is determined for the current point in time, which inverter state specifies the switching states 35, 36, 37 of the switching devices 5, 6 of all half bridges. In the example, it is assumed that the two switching devices 5, 6 of a respective half bridge 2-4 are each switched in diametrically opposed directions, which is to say, that when switching devices 5 is in the blocking state, switching devices 6 is in the conducting state and vice versa. This is expedient inasmuch as the bridge center point 7 of the respective half bridge should always be at a defined potential and a short circuit should be avoided by switching both switching devices 5, 6 to the conducting state. For this reason, the inverter state 34 in the example is completely defined by three switching states 35-37.

In step S2, the number 38 of switching bridges 2-4, whose switching devices 5, 6 are switched over from the previous inverter state 34 to the now desired inverter state 34 when the inverter state 34 is changed, can optionally also be determined. This number is a particularly robust and simple gage for the criticality of the switching process with regard to electromagnetic compatibility or alternatively for the level of emitted interference during a corresponding switching process and is therefore highly relevant for the later elucidated selection of the activation pattern 21-25.

For the sake of simplicity, the subsequent steps S3 to S11 are only elucidated for a single switching device, for example, the switching device 5 that is to be switched. In the example, these steps are carried out for all switching devices 5, 6 of all half bridges 2, 4 for which the respective switching state 35-37 is to be changed when the method is executed.

In step S3, a check is first carried out to determine whether the switching of the respective switching devices 5, 6 is a switching from a conducting to a blocking switching state 35-37. In this case, the procedure is continued in step S4 and otherwise, which is to say, in the case of a changeover from a blocking to a conducting switching state 35-37, in step S7.

In step S4, it is checked whether a triggering condition 39 is fulfilled, the fulfillment of which can in particular indicate that the current switching operation is critical with regard to the electromagnetic compatibility of the inverter 1. In the simplest case, to this end, the number 38 determined in step S2 can be compared with a limit value and, for example, all switching operations can be considered critical or alternatively the triggering condition 39 can be fulfilled for switching operations in which switching devices 5, 6 are switched by two or more of the half bridges 2-4.

Alternatively, such criticality could, for example, be determined directly from the phase 32, in particular by taking into account the amplitude 33, or alternatively, for example, only switching operations, in which a change from or to an inverter state 34 occurs in which the bridge center points 7 of all half bridges 2-4 are connected to the same DC voltage potentials 8, 9, can be regarded as critical, which is to say, for example, when changing to or alternatively from a so-called null vector in a space vector modulation.

If the triggering condition 39 in step S4 is not fulfilled, then the switching devices 5, 6, or alternatively its semiconductor switches 10, 11, are activated in accordance with an activation pattern 21, which leads to a rapid change in resistance of the switching devices 5, 6, which is to say, to rapid switching. An example of a corresponding activation pattern 21 is shown in FIG. 4, wherein the time is shown on the x-axis 26 and the respective gate voltage 28, 29 for the semiconductor switch 10, 11 specified by the control device 12 is shown on the y-axis 27, wherein the curves for the gate voltages 28, 29 are shown offset to each other in the y-direction for reasons of clarity. The gate voltage 29 is supplied to the gate of the first semiconductor switch 10 and the gate voltage 28 is supplied to the gate of the second semiconductor switch 11. As already elucidated above, the first semiconductor switch 10 in the example switches significantly faster than the second semiconductor switch 11.

As can be seen in FIG. 4, the point in time 31, at which the second semiconductor switch 11 is activated in order to transfer it to the blocking state, is noticeably earlier than the point in time 30 at which such an activation takes place for the first semiconductor switch. On the basis of the parallel connection of the semiconductor switches 10, 11 shown in FIG. 2, the switching of the second semiconductor switch 11 at point in time 31 leads at most to a small change in resistance of the respective switching devices 5, 6 and the switching process is characterized by the blocking switching of the first semiconductor switch 10 at point in time 30.

Inasmuch as the first semiconductor switch 10 in the example is a fast-switching semiconductor switch 10, this results in fast and therefore energy-efficient switching of the entire switching devices 5, 6. This fast switching leads to a relatively high emitted interference for the individual switching devices 5, 6 or alternatively for the individual switching bridges 2-4. Inasmuch as the activation pattern 21 is, however, only used in operating situations that are not critical in terms of electromagnetic compatibility, by way of example, when only one of the half bridges 2-4 is switched, this is unproblematic and relatively simple interference suppression filters 17, 19 can still be used.

If, on the other hand, the triggering condition 39 in step S4 is fulfilled, by way of example, because switching devices 5, 6 are to be switched simultaneously by a plurality of the half bridges 2-4, in its stead an activation pattern 22 is used in step S6 for the activation of the semiconductor switches 10, 11, which leads to somewhat slower switching of the respective switching devices 5, 6. Although this results in a slightly higher power loss, at the same time the emitted interference from the respective switching devices 5, 6 can be noticeably reduced, so that the maximum emitted interference caused by the inverter 1 can be noticeably reduced when using such an activation pattern 22 when switching a plurality of the half bridges 2-4.

An example of a suitable activation pattern 22 is shown in FIG. 5. The activation pattern 22 shown there corresponds to the activation pattern 21 shown in FIG. 4, apart from the points in time 30, 31 at which the first or alternatively second semiconductor switch 10, 11 is activated, so that only the effect of the different activation points in time will be elucidated in more detail below.

As can be seen in FIG. 5, in the activation pattern 22, the point in time 30 at which the first semiconductor switch 10 is activated in order to block the first semiconductor switch is significantly earlier than the point in time 31 at which the second semiconductor switch 11 is activated. On the basis of the parallel connection of the semiconductor switches 10, 11, the switching devices 5, 6 remains essentially in the conducting state after the semiconductor switch 10 has been switched to the blocking state. A switchover to the blocking state only occurs when the semiconductor switch 11 is activated at point in time 31. On the basis of the switching behavior of the semiconductor switch 11, the overall switching behavior of the switching devices 5, 6 results in a noticeably slower switchover from the conducting to the blocking state than in the case of the activation pattern 21 whereby the emitted interference can be reduced.

If, on the other hand, the respective switching devices 5, 6 is to be switched from the blocking to the conducting switching state 35-37, the triggering condition 39 is also first checked in step S7. The same applies here as in step S4.

If the triggering condition is not fulfilled, the semiconductor switches 10, 11 are activated in step S8 by a switching pattern 23, which overall leads to a rapid switching off of the switching devices 5, 6, whereby a low power loss is achieved but a relatively high emitted interference can result. This is, however, unproblematic, inasmuch as the non-fulfilment of the triggering condition 39 indicates that the current switching process is not critical in terms of electromagnetic compatibility, by way of example, inasmuch as only one of the half bridges 2-4 is switched.

An example of a suitable activation pattern 23 is shown in FIG. 6. The illustration substantially corresponds to the illustration of the activation patterns 21, 22 in FIGS. 4 and 5 discussed above, so that only the differences will be elucidated below.

It can initially be seen that the gate voltages 28, 29 are increased in the example, this in contrast to the previously discussed activation patterns 21, 22, inasmuch as, in contrast to the activation patterns 21, 22, a conducting switching is to take place rather than blocking switching. The points in time 30, 31, at which the first and second semiconductor switches 10, 11 are activated, are identical in the example in activation pattern 23. Alternatively, it would also be possible, for example, to move the point in time 31, at which the second semiconductor switch 11 is activated, further back in time compared to point in time 30. Notwithstanding whether the points in time 30, 31 are simultaneous or whether the point in time 31 is after the point in time 30, in both cases the switching process of the entire switching devices 5, 6, which is to say, in particular its change in resistance over time, is characterized by the switching process of the first semiconductor switch 10, inasmuch as its switching process is at least clearly completed by the switching process of the second semiconductor switch 11 and thus the slow switching behavior of the second semiconductor switch 11 only insignificantly changes the overall resistance of the switching devices 5, 6. This results in fast and therefore efficient, if however relatively interference-intensive switching, as elucidated above.

If on the other hand the triggering condition 39 is fulfilled in step S7, it is desired that the slow switching process of the semiconductor switch 11 dominates the switching process of the entire switching devices 5, 6, which is then the case if the switching process of this semiconductor switch 11 is already fully completed before the semiconductor switch 10 is activated. This can be achieved, for example, by the activation pattern 24 shown in FIG. 7, which corresponds to the activation pattern 23, apart from a different selection of the points in time 30, 31 used for the activation of the first and second semiconductor switch 10, 11. The point in time 31, at which the second semiconductor switch 11 is activated, is noticeably earlier than the point in time 30 at which the first semiconductor switch 10 is activated, whereby the effect elucidated above is achieved, which is to say, a slower switching with lower efficiency but also lower emitted interference than is achieved for activation pattern 23.

However, if the inverter state 34, which is set by the switching process, is only maintained for a very short time, it may be that the time interval used in the activation pattern 24 between the points in time 31 and 30 would result in the point in time 30 being very close to a point in time at which the corresponding switching devices 5, 6 should already once again be switched to a blocking state or alternatively that a blocking state should already once again be present at this point in time 30. Therefore, instead of the activation pattern 24 shown in FIG. 7, the activation pattern 25 shown in FIG. 8 can also be used, in which only the second semiconductor switch 11 is activated to change its switching state by changing the gate voltage 28, whereas the gate voltage 29 for the first semiconductor switch 10 remains substantially more constant and therefore no activation or alternatively change of state of this semiconductor switch 10 takes place. Accordingly, when using the activation pattern 25, when the respective switching device 5, 6, is subsequently switched to the blocking switching, only the switching state of the second semiconductor switch 11 is changed in this case, inasmuch as the first semiconductor switch 10 remains in a continuously blocking mode in this case.

For the reasons mentioned, it can initially be checked in step S9 whether an expected time for which the inverter state 34 is to be maintained, or alternatively for which a conductive switching state 35-37 of the respective switching device is expected to be maintained, is below a limit value. If this is not the case, the activation pattern 24 can be used in step S10, which potentially enables particularly low losses on the basis of the conductive switching of both switching devices 5, 6. If, on the other hand, the time limit value is undershot in step S9, activation pattern 25 can be used in step S11.

After the semiconductor switch 10, 11 has been activated by the selected activation pattern 21-25 in one of the steps S5, S6, S8, S10 or S11, the method can be repeated from step S1, wherein, in particular, at least the phase 32 is automatically adjusted according to the elapsed time.

German patent application no. 102023102550.3, filed Feb. 2, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating an inverter with a plurality of half bridges, wherein each of the half bridges includes two switching devices that connect respective bridge center points of the half bridges to respective Direct Current (DC) voltage potentials, wherein each of the switching devices is switchable between a conducting switching state and a blocking switching state, wherein switching of the switching devices takes place between different inverter states, wherein each of the inverter states differs from one another with respect to a switching state of each of the switching devices of at least one of the half bridges, wherein at least one of the switching devices has variable switching behavior and includes a parallel connection of two semiconductor switches that are configured differently from one another, the method comprising at least one of:
for at least two temporally successive switching operations of the at least one of the switching devices from the conducting switching state to the blocking switching state, activating the semiconductor switches using first activation patterns; or
for the at least two temporally successive switching operations of the at least one of the switching devices from the blocking switching state to the conducting switching state, activating the semiconductor switches using second activation patterns.

2. The method according to claim 1, wherein
the first activation patterns and the second activation patterns depend on a phase of an Alternating Current (AC) voltage provided or present at at least one of the bridge center points, and/or on the phase of the AC current provided or present at the at least one of the bridge center points, and/or on a number of half bridges having switching devices that are switched when one of the inverter states is changed.

3. The method according to claim 1, wherein
a first one of the semiconductor switches has a shorter switching time for a change from the blocking switching state to the conducting switching state and/or from the conducting switching state to the blocking switching state than a second one of the semiconductor switches.

4. The method according to claim 1, wherein
a first one of the semiconductor switches is a Metal Oxide Semiconductor Field Effect Transistor (MOSFET), and a second one of the semiconductor switches is an Insulated-Gate Bipolar Transistor (IGBT).

5. The method according to claim 4, wherein
the first one of the semiconductor switches is a silicon carbide MOSFET, and the second one of the semiconductor switches is a silicon IGBT.

6. The method according to claim 1, wherein
to activate the at least one of the semiconductor switches from the conducting switching state to the blocking switching state, a first one of the first activation patterns is used if a triggering condition is not fulfilled, wherein fulfillment of the triggering condition indicates a presence of a switching of the inverter states that is critical for electromagnetic compatibility, and a second one of the first activation patterns is used if the triggering condition is fulfilled, wherein in the second one of the activation patterns a second one of a second semiconductor switches, starting from a time of activation of a first one of the semiconductor switches is activated later than in the first one of the first activation patterns.

7. The method according to claim 1, wherein
to activate at least one of the semiconductor switches from the blocking switching state to the conducting switching state, a third activation pattern is used if a triggering condition is not fulfilled, wherein fulfillment of the triggering condition indicates a presence of a switching of the inverter states that is critical for electromagnetic compatibility and, in response to fulfillment of the triggering condition, a fourth activation pattern is used, wherein, starting from a time of triggering of a first one of the semiconductor switches, wherein in the fourth activation pattern either a second one of the semiconductor switches is activated earlier than in the third activation pattern, or only the second one of the semiconductor switches is activated.

8. The method according to claim 7, wherein
the fulfilment of the triggering condition depends on whether, when the inverter states change from a previous inverter state to a new inverter state, the previous inverter state and/or the new inverter state is an inverter state in which the bridge center points of all of the half bridges are connected to a same DC voltage potential.

9. An inverter comprising:
a plurality of half bridges, wherein each half bridge of the half bridges includes two switching devices that, in operation, connect a bridge center point of the half bridge to a respective Direct Current (DC) voltage potential; and
a control device that, in operation, controls the switching devices,
wherein at least one of the switching devices has variable switching behavior and includes a parallel connection of two semiconductor switches that are designed differently from one another, and
wherein the control device, in operation,
for at least two temporally successive switching operations of the at least one of the switching devices from a conducting switching state to a blocking switching state, the semiconductor switches using first activation patterns; or
for the at least two temporally successive switching operations of each of the at least one of the switching devices from the blocking switching state to the conducting switching state, activate the semiconductor switches using second activation patterns.

10. A motor vehicle, comprising an inverter according to claim 9.

11. The motor vehicle according to claim 10, wherein the inverter, in operation, supplies current to a drive motor of the motor vehicle.
